(19) United States
(12) Patent Application Publication
(10) Pub. No.: US 2016/0176742 A1
(43) Pub. Date: Jun. 23, 2016

(54) Natural Effluent Remediation System

(71) Applicants: Jeremy S. Starks, Scott Depot, WV (US); Joshua R. Justice, Danville, WV (US); Chris W. White, Danville, WV (US); Anthony J. White, Sumerco, WV (US); Jeffery W. Allen, Scott Depot, WV (US)

(72) Inventors: Jeremy S. Starks, Scott Depot, WV (US); Joshua R. Justice, Danville, WV (US); Chris W. White, Danville, WV (US); Anthony J. White, Sumerco, WV (US); Jeffery W. Allen, Scott Depot, WV (US)

(21) Appl. No.: 14/979,075

(22) Filed: Dec. 22, 2015

Related U.S. Application Data
(60) Provisional application No. 62/095,481, filed on Dec. 22, 2014.

(51) Int. Cl. C02F 9/00; C02F 1/00

(52) U.S. Cl. CPC C02F 9/00; C02F 1/008; C02F 2101/106

(57) ABSTRACT

A system of treating discharge water from a National Pollution Discharge Elimination Systems (NPDES) by utilizing naturally occurring groundwater containing increased levels of naturally occurring chemical or mineral elements or compounds as a catalyst to induce a reaction with the non-compliant chemical or mineral element or compound of the discharge water, resulting in a reduction of the discharge contaminate to a level which does not exceed state or federal water quality standards.

### CROSS-REFERENCE TO RELATED APPLICATIONS

This application claims the benefit of U.S. Provisional Application No. 62/095,481, entitled “Natural Effluent Remediation System (N.E.R.S)” and filed on Dec. 22, 2014. The complete disclosure of such provisional patent application is hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates generally to a system to control water pollution, and more particularly to a system to control water pollution by treating discharge water of National Pollution Discharge Elimination Systems.

2. Brief Description of the Related Art

The Clean Water Act (“the Act”) is a federal law governing water pollution in the United States. The Act was enacted to control pollution in both point and nonpoint sources. Point sources are discrete conveyances such as pipes or man-made ditches or channels. The Act helps to control water pollution from point sources by requiring that all construction sites on an acre or greater of land, in addition to municipal, industrial, and commercial facilities discharging wastewater directly from a point source into a surface water of the United States (lakes, rivers, oceans), obtain permission under a National Pollutant Discharge Elimination System (NPDES) permit. These NPDES permits regulate wastewater discharges by limiting the quantities of pollutants to be discharged and imposing monitoring requirements and other conditions. The limits and/or requirements in the permit help ensure compliance with the federal regulations and state regulations where the facility is located.

The two most common systems for treating discharge water from National Pollution Discharge Elimination Systems are bioreactor systems and reverse osmosis systems. However, the performance of the bioreactor system is greatly affected by external environmental conditions, such as flow, temperature, and sensitivity to calcium precipitate. The reverse osmosis systems may be effective in some circumstances, but they are extremely expensive and require significant construction and manpower. The present invention overcomes the drawbacks of the prior art treatment systems by providing a system using naturally occurring groundwater containing iron to treat any water source containing measurable selenium levels.

### BRIEF SUMMARY OF THE INVENTION

The present invention is directed to a Natural Effluent Remediation System utilizing naturally occurring groundwater as a catalyst to treat the discharge water of National Pollution Discharge Elimination Systems (NPDES). It is an object of the present invention to provide a system that results in the reduction of discharge contaminates to levels below state or federal water quality standards.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a schematic of a first embodiment of the system of the present invention.

FIG. 2 is a schematic of a second embodiment of the system of the present invention.

### DETAILED DESCRIPTION OF THE INVENTION

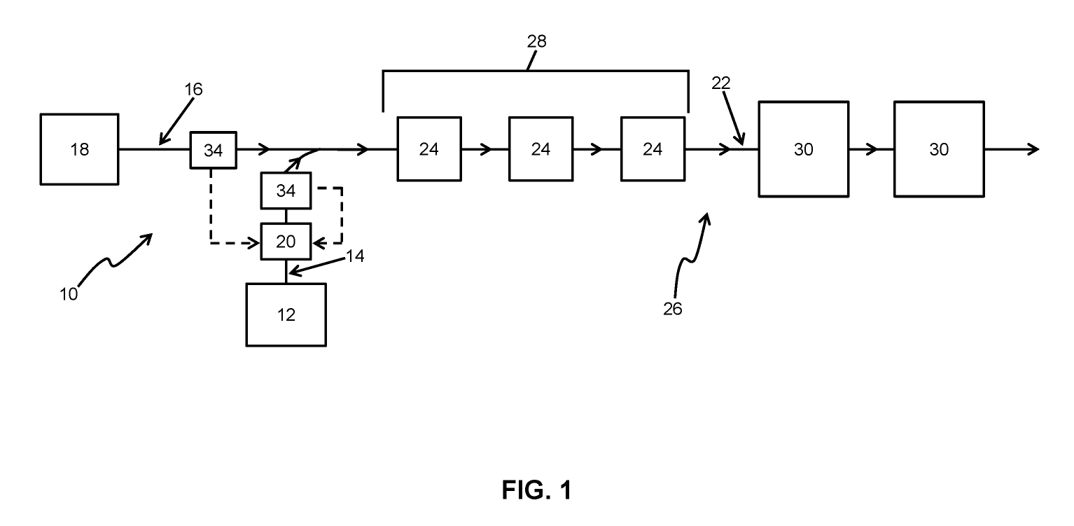

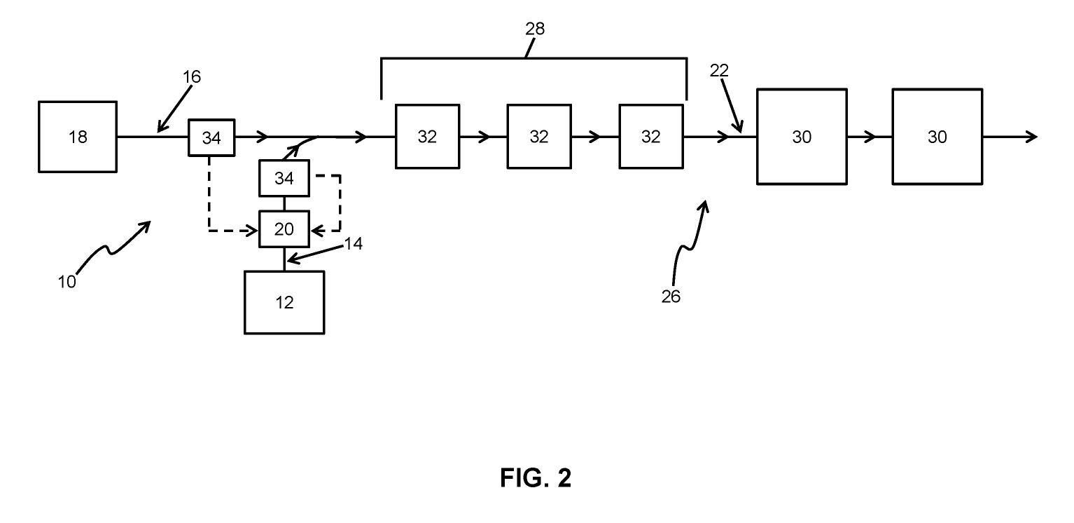

With reference to FIGS. 1-2, the preferred embodiment of the present invention may be described. This system 10 for treating discharge water utilizes strategically placed water wells or other water sources 12 (artificially created or naturally occurring) to access naturally occurring groundwater 14 containing increased levels of specific naturally occurring chemical or mineral elements (e.g. iron or any other negatively charged metal) to be used as a catalyst to induce a reaction with the non-compliant chemicals or minerals (e.g. selenium) in a non-compliant discharge water or wastewater 16 from a point or non-point water source 18. The groundwater from the water source 12 is then pumped via a pump 20 or gravity fed into a mixing area 26 where the collected groundwater is mixed with the untreated discharge water at a predetermined mixing ratio, resulting in the natural treatment of a regulated discharge water sufficient to bring the discharge water into compliance with state and federal water quality standards. The state and federal water quality standards set forth the acceptable levels of certain chemical contaminants in the treated discharge water 22.

In one embodiment, the treatment system uses naturally occurring groundwater containing increased iron concentration to perform a common reduction reaction between iron and selenium. This is a two-step reduction oxidation and physical adsorption process where ferrous iron is added resulting in the reduction of selenate to selenite and the subsequent physical adsorption or co precipitation of selenite by ferrihydrite or ferric. Naturally occurring increased concentrations of iron water from a groundwater source are blended with water from a raw discharge source containing selenium, including from point and non-point sources 18. The reaction renders iron oxide selenium complexes which precipitate from the water column causing both a reduction of selenium in the discharge and a complex that renders the selenium biological unavailable, which means that organisms cannot access the iron. The groundwater source is preferably a well 12. The treatment of the discharge water with the groundwater preferably is concurrent with the oxidation of the system through the use of aeration to induce the desired reaction. The aeration can be achieved mechanically (through the use of agitators or aerators) or through the use of the natural stream restoration technique of constructing step-pools 24. Either method leads to increased dissolved oxygen levels in the water.

The system may include a pump 20 configured to pump iron-containing source water (e.g., groundwater from a well) through a water passage (e.g. pipe or other water passage well-known to those skilled in the art) into a mixing area 26 where the iron-containing source water is commingled, or mixed, with raw discharge water from the discharge source to facilitate treatment of the water to form treated discharge water 22. The raw discharge water is passed through a water passage (e.g. pipe or other water passage well-known to those skilled in the art) from the wastewater source 18 to the mixing area 26. In one embodiment, the mixing area includes a number of oxygenating channels. For example, an artificial channel 28 may be used containing a series of step pools 24. The step pools are preferably of the type well-known to those skilled in the art, such as pools of water separated by cobble steps. The number of step pools needed depends on the concentration of iron in the groundwater. The higher the concentration in the groundwater, then greater the number of step pools needed. The purpose of the step pools is for oxygenation of the groundwater-discharge water mixture. As the mixture flows through the step pools, the dissolved oxygen in the mixture increases. The iron from the groundwater and the oxygen in the pools are combined during the redox reaction to form iron oxide. The selenium from the discharge water binds to the iron oxide. This iron-selenium complex is no longer biologically active. In one embodiment, the step pools lead into one or more wetlands areas 30. The wetlands create additional treatment zones or mixing areas and capture iron and selenium precipitate in the water. In another embodiment, especially when space is limited, the mixing area may include a series of mixing tanks 32 instead of a series of step pools. The mixing tanks are preferably connected either by pipes or other means to allow the water to flow from tank to tank. The resulting treated wastewater is transported through a pipe or other water passage well-known to those skilled in the art to a receiving stream or other body of water (e.g. river, stream, lake, pond, ditch).

A flow rate of the pump 20 is set such that the amount of selenium content in the treated water yielded from this process is less than a predefined threshold level such as, for example, a level set by federal and/or state regulatory bodies. The pump flow rate may be manually configured by an operator to compensate for any changes in the flow rate of the discharge water. Alternatively, the flow rate may be programmatically and dynamically configurable to compensate for any changes in the flow rate of the discharge water. In one exemplary embodiment, the flow rate is adjusted such that the mixing ratio of discharge water to iron-containing water is 1:1. In another exemplary embodiment, the flow rate is adjusted such that the mixing ratio of discharge water to iron-containing water is 2:1. In yet another exemplary embodiment, the flow rate is adjusted such that the mixing ratio of discharge water to iron-containing water is 3:1. The ratios may also differ from those disclosed above, but the flow rate is adjusted to achieve the desired treatment. The flow rate is optimized to prevent excess iron while still maintaining sufficient iron to bind the selenium present.

The desired mixing ratio of iron-containing groundwater 14 to discharge water 16, and thus the flow rate of the iron-containing groundwater from the pump, may vary depending on the amount of iron in the iron-containing groundwater and the amount of selenium in the discharge water. As such, in one embodiment, an amount of selenium in the discharge water and an amount of iron in the iron-containing source water are measured. Based on the amount of selenium in the discharge water and the amount of iron in the iron-containing water, a desired mixing ratio of discharge water to iron-containing water is determined. For example, a standard curve is established comparing selenium discharge levels and flow as compared to iron concentrations. In general, the desired mixing ratio is a mixing ratio at which the selenium content in the treated water is reduced below a predefined level (e.g., a level set by federal and/or state regulatory agencies). The flow rate of the pump is then set based on the flow rate of the discharge water to provide the desired mixing ratio. The flow rate may thereafter be dynamically adjusted, either manually or programmatically through use of an electronic control system 34, to compensate for any changes in the flow rate of the discharge water. In a similar manner, the amount of selenium in the discharge water and/or the amount of iron in the iron-containing groundwater may be dynamically monitored, such that the flow rate of the pump can be adjusted either manually or programmatically to account for changes in the amount of selenium in the discharge water and/or the amount of iron in the iron-containing groundwater. The amount of selenium in the discharge water and/or the amount of iron in the iron-containing source water can be monitored manually or programmatically using commercially-available monitoring systems, which is a component of the electronic control system 34.

While the discussion above focuses on an embodiment where there is one pump and one mixing area (one mixing stage), the present disclosure is not limited thereto. In another embodiment, the mixing of the iron-containing groundwater and the discharge water may be performed in multiple mixing stages or treatment zones, which are contiguous. Each mixing stage may utilize iron-containing water from the same iron-containing source (e.g., the output of the pump may be split and delivered to each mixing stage) or may utilize iron-containing water from multiple iron-containing sources (e.g., different groundwater wells using different pumps).

In an alternative embodiment, the described system treats acid discharges and or streams by using naturally occurring groundwater sources 12 containing increased alkalinity which is injected or mixed into an acid condition discharge. Excess calcium carbonate in the groundwater reduces acidity in the water being treated. Discharge water that has a low pH value or acidic condition is normally treated using ari alkaline based treatment that falls into two categories: chemical treatment (i.e. sodium hydroxide, ammonium hydroxide) or passive treatment using limestone or other material containing excess calcium carbonate. The drawback of using any chemical treatment is the risk of over treatment or mechanical failure both of which either result in excess chemical in the system or under treatment allowing discharges to increase above the level mandated by federal and/or state regulatory bodies. The passive treatment systems fail to achieve the mandated levels established by federal and/or state regulatory bodies due to the oxidation of metal and other complexes which precipitate on the alkaline material resulting in an armoring of the alkaline substrate material thus reducing the desired amount of excess calcium carbonate to be released in the system. The present system accesses naturally occurring groundwater aquifers with increased levels of calcium carbonate or alkalinity. The groundwater utilized as the catalyst is then pumped or gravity fed at a predetermined mixing ratio with the acidic discharge water to result in a reduction of the acidic condition of the discharge water. Natural stream design techniques or artificial aeration (agitators or aerators) can be utilized to create an oxidation reducing conditioned coupled with the slightly alkaline condition derived through the groundwater injection will reduce the likelihood of over treatment with a toxic chemical or under treatment due to armoring of the substrate as the excess calcium carbonate is dissolved in the groundwater source.

The system and operation thereof for acid reduction using groundwater sources is substantially the same as that described above for selenium treatment. Specifically, in one embodiment, one or more pumps are configured to pump groundwater containing excess calcium carbonate or alkalinity to one or more mixing areas to be commingled, or mixed, with the discharge water having an acid condition. The mixing ratio of groundwater to discharge water is established, and in some embodiments dynamically adjusted, either manually or programmatically, to compensate for any changes in the flow rate of the discharge water, such that the treated water has a neutral or alkaline condition.

The present system can be used to treat other issues of non-compliant discharge water 16 (e.g. acid mine discharge) by utilizing naturally occurring groundwater 14 as a catalyst to induce a reaction with the non-compliant chemical aspect of the discharge. Groundwater is pumped from wells or other sources 12 containing the chemical elements necessary to counter the non-compliant chemical or condition of the discharge water. The mixing ratio of the groundwater and the discharge water shall be determined by the amount of each chemical constituent required to achieve the desired counteractive effect on the discharge to result in compliance of said discharge to state and federal regulatory bodies mandated requirements for said discharge

The present invention has been described with reference to certain preferred and alternative embodiments that are intended to be exemplary only and not limiting to the full scope of the present invention.

We claim:

1. A system for treating wastewater, comprising:
(a) a source of untreated wastewater;
(b) a source of groundwater;
(c) a mixing area in communication with said source of untreated wastewater and said source of groundwater;
(d) a first water passage configured for passing untreated wastewater comprising a concentration of a first chemical element or compound from said source of untreated wastewater to said mixing area; and
(e) a second water passage configured for passing groundwater comprising a concentration of a second chemical element or compound from said source of groundwater to said mixing area.
(f) a third water passage configured for passing treated wastewater from said mixing area.

2. The system of claim 2, further comprising a pump, wherein said pump is configured to move said groundwater through said second water passage system to said mixing area.

3. The system of claim 1, wherein said mixing area comprises an artificial channel comprising at least one step pool.

4. The system of claim 1, wherein said mixing area comprises at least one wetland area.

5. The system of claim 1, wherein said mixing area comprises at least one mixing tank.

6. The system of claim 1, further comprising an electronic control system.

7. The system of claim 6, wherein said electronic control system is operable to detect said concentration of said second chemical element or compound from said groundwater.

8. The system of claim 6, wherein said electronic control system is operable to detect said concentration of said first chemical element or compound from said untreated wastewater.

9. The system of claim 2, wherein said pump is operable to control the ratio of said concentration of said first chemical element or compound and said concentration of said second chemical element or compound in said treated wastewater.

10. The system of claim 1, further comprising an agitator or an aerator in communication with said mixing area.

11. A method of treating wastewater, comprising the steps of:
(a) passing untreated wastewater comprising a first concentration of a first chemical element or compound into a mixing area;
(b) passing groundwater comprising a concentration of a second chemical element or compound into said mixing area;
(c) mixing said untreated wastewater and said groundwater, thereby yielding treated wastewater comprising a second concentration of said first chemical element or compound.

12. The method of claim 10, wherein said mixing area comprises an artificial channel comprising at least one step pool.

13. The method of claim 11, wherein said mixing area comprises at least one wetland area.

14. The method of claim 11, wherein said mixing area comprises at least one mixing tank.

15. The method of claim 11, wherein said step of passing untreated wastewater comprises passing said untreated wastewater from a point or non-point water source.

16. The method of claim 11, wherein said step of passing groundwater comprises pumping said groundwater from a groundwater source to said mixing area.

17. The method of claim 11, further comprising the step of passing said treated wastewater from said mixing area.

18. The method of claim 11, wherein said concentration of a first chemical element or compound is a concentration of selenium.

19. The method of claim 11, wherein said concentration of a second chemical element or compound is a concentration of iron.

20. The method of claim 11, wherein said concentration of a second chemical element or compound is a concentration of calcium carbonate.
